(19) United States
(12) Patent Application Publication
(10) Pub. No.: US 2023/0204808 A1
(43) Pub. Date: Jun. 29, 2023

(54) METHOD AND DEVICE FOR DETERMINING SEISMIC WAVE INFORMATION, AND COMPUTER READABLE STORAGE MEDIUM

(71) Applicant: Chengdu University of Technology, Chengdu City (CN)

(72) Inventors: Yuyong YANG, Chengdu City (CN); Qiaomu QI, Chengdu City (CN); Huailai ZHOU, Chengdu City (CN); Haoqing HUANG, Chengdu City (CN)

(21) Appl. No.: 17/899,677

(22) Filed: Aug. 31, 2022

(30) Foreign Application Priority Data
Dec. 27, 2021 (CN) 202111615650.3

(51) Int. Cl. G01V 1/30; G01V 1/18

(52) U.S. Cl. CPC G01V 1/30; G01V 1/181; G01V 2210/165; G01V 2210/144

(57) ABSTRACT

A method and device determine seismic wave information, and a computer readable storage medium implements a method for determining seismic wave information. According to the solution, the method includes determining shallow and deep geophones from top to bottom in a vertical depth direction; determining, according to horizontal component signals acquired by each of the shallow geophones and a preset function, a polarization direction of the horizontal component signal acquired to obtain an azimuth of the shallow geophone; determining, according to an event inclination angle of a scalar signal in horizontal component signals acquired by each of the deep geophones, and a correlation between the deep geophone and a forward adjacent geophone in horizontal component signal based on the event inclination angle, an azimuth of the deep geophone; and determining, according to the horizontal component signals and the azimuth of each of geophones, a radial and a tangential component of the target seismic wave.

### CROSS REFERENCE TO RELATED APPLICATION

This patent application claims the benefit and priority of Chinese Patent Application No. 202111615650.3, entitled “METHOD AND DEVICE FOR DETERMINING SEISMIC WAVE INFORMATION, AND COMPUTER READABLE STORAGE MEDIUM” filed on Dec. 27, 2021, the disclosure of which is incorporated by reference herein in its entirety as part of the present application.

### TECHNICAL FIELD

The present disclosure relates to the technical field of seismic waves, and in particular to a method and device for determining seismic wave information, and a computer readable storage medium.

### BACKGROUND ART

For scenarios such as oil and gas exploration, in a well with a depth of several hundred to several thousand meters and having an exploration drill bit provided therein, there are a plurality of geophones sequentially arranged at a preset interval from top to bottom in the vertical depth direction of the well. Artificial seismic waves generated by using vibroseis on the ground travels through a wellhead to each three-component geophone arranged in the well, and the geophones each collect the x-component signals, y-component signals, and z-component signals of a seismic wave signal. Through the analysis of the three-component seismic wave signal data collected by the geophones, a seismic wave field is recovered, which in turn allows for understanding of the structure of the underground layer where the well is located.

However, preliminary seismic wave signals are weak and easily masked by noise, making it difficult to accurately determine the azimuth of the geophone arranged at a corresponding deep according to the preliminary wave signals. As a result, it is impossible to recover information about the seismic wave field effectively, or to grasp the accurate structure of the underground layer.

How to accurately determine the azimuth of the geophone and effectively recover seismic wave information is a technical problem to be solved in the present disclosure.

### SUMMARY

The embodiments of the present disclosure aim to provide a method and device for determining seismic wave information, and a computer readable storage medium, so as to resolve the problem that seismic wave field information is hard to recover due to fail to acquire accurate azimuths of geophones.

In order to solve the technical problems above, the specification is implemented as follows.

In a first aspect, the present disclosure provides a method for determining seismic wave information, including:

determining shallow and deep geophones from a plurality of geophones sequentially arranged at a preset interval from top to bottom in a vertical depth direction;

determining, according to horizontal component signals of a target seismic wave acquired by each of the shallow geophones within a corresponding first arrival time window and a preset function, a polarization direction of the horizontal component signals acquired within the corresponding first arrival time window to obtain an azimuth of each shallow geophone;

determining, according to an event inclination angle of a scalar signal in horizontal component signals of the target seismic wave acquired by each of the deep geophones within a preset acquisition time window, and a correlation between the deep geophone and a forward adjacent geophone in horizontal component signal based on the event inclination angle, an azimuth of the deep geophone, where the preset acquisition time window includes the first arrival time window; and

determining, according to the horizontal component signals of the target seismic wave acquired within the preset acquisition time window and the azimuth of each of geophones, a radial seismic wave component and a tangential seismic wave component of the target seismic wave.

In some embodiments, said determining shallow and deep geophones from a plurality of geophones sequentially arranged at a preset interval from top to bottom in a vertical depth direction specifically includes:

determining, according to the horizontal component signals of the target seismic wave acquired by each of the geophones within the corresponding first arrival time window, an elliptical polarization rate of each geophone; and

determining, according to respective elliptical polarizabilities, shallow and deep geophones from the plurality of geophones.

In some embodiments, the horizontal component signals of the target seismic wave include secondary wave (S-wave) signals and primary wave (P-wave) signals, and

said determining, according to the horizontal component signals of the target seismic wave acquired by each of the geophones within the corresponding first arrival time window, an elliptical polarizabilities of the geophone specifically includes:

calculating an average value of S-wave signals and an average value of P-wave signals acquired by a target geophone within the target first arrival time window:

determining, according to the S-wave signals, the P-wave signals, the average value of the S-wave signals, and the average value of the P-wave signals, a covariance matrix corresponding to the horizontal component signals of the target seismic wave acquired by the target geophone; and

determining, according to a ratio of a maximum eigenvalue to a minimum eigenvalue of the covariance matrix, an elliptical polarizability of the target geophone.

In some embodiments, said determining shallow and deep geophones from a plurality of geophones sequentially arranged at a preset interval from top to bottom in a vertical depth direction specifically includes:

determining a geophone arranged at an uppermost part in the vertical depth direction as a shallow geophone; and

determining other geophones below the geophone arranged at the uppermost part in the vertical depth direction as deep geophone.

In some embodiments, said determining, according to horizontal component signals of a target seismic wave acquired by each of the shallow geophones within a corresponding first arrival time window and a preset function, a polarization direction of the horizontal component signal acquired within the corresponding first arrival time window specifically includes:

calculating an average value of S-wave signals and an average value of P-wave signals acquired by a target shallow geophone within the corresponding first arrival time window;

determining, according to the S-wave signals, the P-wave signals, the average value of the S-wave signals, and the average value of the P-wave signals, a covariance matrix corresponding to the horizontal component signals of the target seismic wave acquired by the target shallow geophone; and

determining, according to an eigenvector corresponding to a maximum eigenvalue of the covariance matrix, a polarization direction of the horizontal component signals of the target seismic wave acquired by the target shallow geophone.

In some embodiments, said determining an azimuth of each of the deep geophones specifically includes:

determining, according to the horizontal component signals of the target seismic wave acquired by a target deep geophone at a target moment within the preset acquisition time window, a target scalar signal;

determining an event inclination angle of the target scalar signal;

determining, under each of different azimuths, a correlation between the target deep geophone and a forward adjacent geophone in horizontal component signals based on the event inclination angle; and

determining, according to an azimuth corresponding to a maximum of correlations under the different azimuths, the azimuth of the target deep geophone.

In some embodiments, said determining, under each azimuth of the different azimuths, a correlation between the target deep geophone and a forward adjacent geophone in horizontal component signal based on the event inclination angle specifically includes:

determining, according to a horizontal component signal of the target seismic wave acquired by the target deep geophone at each moment within the preset acquisition time window, a scalar signal corresponding to each moment and a radial seismic wave component and a tangential seismic wave component of the target seismic wave under each azimuth;

determining an event inclination angle corresponding to the scalar signal at each moment;

determining, according to an event inclination angle of the target deep geophone at each moment within the preset acquisition time window, and an interval between the target deep geophone and a forward adjacent geophone in the vertical depth direction, a correlation between the target deep geophone and the forward adjacent geophone in radial seismic wave component based on the event inclination angle and a correlation between the target deep geophone and the forward adjacent geophone in tangential seismic wave component based on the event inclination angle; and

determining, according to a sum of the correlation in radial seismic wave component and the correlation in tangential seismic wave component, a correlation in horizontal component signals.

In some embodiments, said determining, according to an event inclination angle of the target deep geophone at each moment within the preset acquisition time window, and an interval between the target deep geophone and a forward adjacent geophone in the vertical depth direction, a correlation between the target deep geophone and the forward adjacent geophone in radial seismic wave component based on the event inclination angle and a correlation between the target deep geophone and the forward adjacent geophone in tangential seismic wave component based on the event inclination angle specifically includes:

determining, according to an event inclination angle of the target deep geophone at each moment within the preset acquisition time window, and an interval between the target deep geophone and a forward adjacent geophone in the vertical depth direction, a correlation between the target deep geophone and the forward adjacent geophone in horizontal component signal based on the event inclination angle at each moment within the preset acquisition time window;

determining, from all moments, a target moment corresponding to a maximum of correlation in horizontal component signals for all moments;

determining a constraint time window according to the target moment, where a time length of the constraint time window is less than that of the preset acquisition time window; and

determining, according to an event inclination angle of the target deep geophone at each moment within the constraint time window, and an interval between the target deep geophone and a forward adjacent geophone in the vertical depth direction, a correlation between the target deep geophone and the forward adjacent geophone in radial seismic wave component based on the event inclination angle and a correlation between the target deep geophone and the forward adjacent geophone in tangential seismic wave component based on the event inclination angle.

In a second aspect, the present disclosure provides a device for determining seismic wave information, including a memory and a processor, where the processor is electrically connected to the memory; the memory stores a computer program executable on the processor; and the computer program can be executed by the processor to implement the steps of the method according to the first aspect.

In a third aspect, the present disclosure provides a computer readable storage medium having a computer program stored thereon, and the computer program, when executed by a processor, implements steps of the method described in the first aspect.

In the embodiments of the present disclosure, the method includes: determining shallow and deep geophones in a plurality of geophones sequentially arranged at a preset interval from top to bottom in a vertical depth direction; determining, according to horizontal component signals of a target seismic wave acquired by each of the shallow geophones within a corresponding first arrival time window and a preset function, a polarization direction of the horizontal component signal acquired within the first arrival time window to obtain an azimuth of each shallow geophone; determining, according to an event inclination angle of a scalar signal in horizontal component signals of the target seismic wave acquired by each of the deep geophones within a preset acquisition time window, and a correlation between the deep geophone based on the event inclination angle and a forward adjacent geophone in horizontal component signals, an azimuth of each deep geophone; and determining, according to the azimuth of each of the geophones and the horizontal component signals of the target seismic wave acquired within the preset acquisition time window, a radial seismic wave component and a tangential seismic wave component of the target seismic wave. As a result, the problem that it is difficult to obtain accurate azimuths of a geophone using preliminary seismic waves due to noise masking can be avoided, so as to improve the accuracy of the azimuth of each geophone, and thus the wave field information of the target seismic wave can be recovered accurately and effectively.

### BRIEF DESCRIPTION OF THE DRAWINGS

The drawings described here are provided for further understanding of the present disclosure, and constitute a part of the present disclosure. The exemplary embodiments of the present disclosure and illustrations thereof are intended to explain the present disclosure, but do not constitute inappropriate limitations to the present disclosure.

FIG. 1 is a schematic flowchart of a method for determining seismic wave information according to an embodiment of the present disclosure.

FIG. 2 is a schematic flowchart of a method for determining seismic wave information according to an example of the present disclosure.

FIG. 3 is structural block diagram of a device for determining seismic wave information according to an embodiment of the present disclosure.

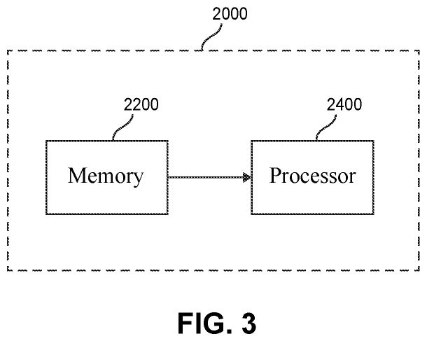

### DETAILED DESCRIPTION OF THE EMBODIMENTS

The technical solutions in the embodiments of the present invention are clearly and completely described below with reference to the accompanying drawings in the embodiments of the present disclosure. Apparently, the described embodiments are merely some rather than all of the embodiments of the present disclosure. All other embodiments obtained by those of ordinary skills in the art based on the embodiments of the present disclosure without creative efforts should fall within the protection scope of the present disclosure. The reference numbers of accompanying drawings in the present disclosure are only intended to distinguish various steps in the solution, rather than limit the execution sequence of various steps. The specific execution sequence shall be subject to the description in the Specification.

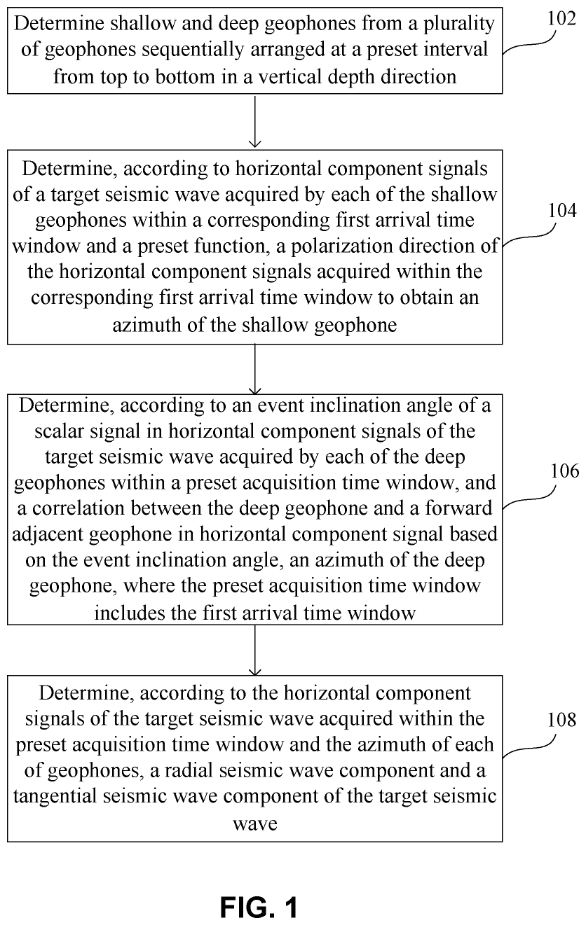

In order to solve the problems in the prior art, embodiments of the present disclosure provide a method for determining seismic wave information. FIG. 1 is a schematic flowchart of a method for determining seismic wave information according to an embodiment of the present disclosure.

As shown in FIG. 1, the method includes the following steps.

In step 102, shallow and deep geophones in a plurality of geophones sequentially disposed at a preset interval from top to bottom in a vertical depth direction are determined.

In step 104, a polarization direction of the horizontal component signal acquired within the first arrival time window is determined, according to horizontal component signals of a target seismic wave acquired by each of the shallow geophones within a corresponding first arrival time window and a preset function, to obtain an azimuth of the shallow geophone.

In step 106, an azimuth of the deep geophone is determined, according to an event inclination angle of a scalar signal in horizontal component signals of the target seismic wave acquired by each of the deep geophones within a preset acquisition time window, and a correlation between the deep geophone and a forward adjacent geophone in horizontal component signal based on the event inclination angle, where the preset acquisition time window includes the first arrival time window.

In step 108, a radial seismic wave component and a tangential seismic wave component of the target seismic wave are determined, according to the azimuth of each of the geophones and the horizontal component signals of the target seismic wave acquired within the preset acquisition time window.

There are a plurality of geophones for acquiring seismic signals in the well. The geophones described herein are three-component geophones, which are used to acquire the component signals of seismic waves along the three directions of x, y and z. The x and y component signals are collectively known as the horizontal component signals of seismic waves, and z component signals are called as the vertical component signals of seismic waves. These geophones are sequentially arranged in the vertical depth space of the well at a preset interval from top to bottom in the vertical depth direction of the well.

The first arrival time window is determined according to the first arrival moment at which a target seismic wave first arrives at each geophone, and each geophone has a fixed first arrival moment. According to the first arrival moment of each geophone, a corresponding first arrival time window is defined. When a plurality of geophones are numbered from top to bottom in the vertical depth direction, the uppermost geophone is numbered as the 1st geophone, followed by the 2nd geophone, the 3rd geophone, the 4th geophone, . . . , the nth geophone.

For example, if the first arrival moment of the 10th geophone is the 100th millisecond, and the length of the first arrival time window is set as 10 milliseconds, the first arrival time window corresponding to the 95th milliseconds to the 105th milliseconds can be obtained with the 100th millisecond as the center.

The preset acquisition time window is the time for each geophone to acquire seismic wave signals, such as 5 seconds. Within the 5 seconds, all geophones are supposed to acquire the seismic wave signals from the moment 0 until the acquisition time for 5 seconds has expired. At the acquisition time point when the seismic wave has not yet reach the geophone, the seismic wave signal is 0, which will not change until the seismic wave signal arrives. That is, the preset acquisition time window includes the first arrival time windows of various geophones, and the first arrival time windows of different geophones corresponds to different time periods within the preset acquisition time window.

In the embodiment of the present disclosure, firstly, a plurality of geophones are classified into shallow and deep geophones. As the name suggests, a shallow geophone is located in the upper part of a well and near the ground wellhead or at a shallower position, and a deep geophone is located in the lower part of the well and far from the ground wellhead or at a deeper position.

Based on the solution according to the above embodiment, optionally, in an embodiment, said determining shallow and deep geophones in a plurality of geophones sequentially arranged at a preset interval from top to bottom in a vertical depth direction in step 102 specifically includes: determining, according to the horizontal component signals of the target seismic wave acquired by each of the geophones within the corresponding first arrival time window, an elliptical polarizability of the geophone; and determining, according to the elliptical polarizability, shallow and deep geophones in all of the geophones.

In this embodiment, the elliptical polarizability of each geophone is calculated to determine whether the geophone is located in the deep or shallow layer of a well, and the elliptical polarizability characterizes the linear polarization intensity of the seismic wave signals.

The smaller the elliptical polarizability is, the stronger the linear polarization of a seismic wave signal is, that is, the geophone is located in the shallow layer, and the seismic wave signal is strong and less prone to noise masking. On the contrary, the greater the elliptical polarization rate is, the weaker the linear polarization of the seismic wave signal is, that is, the geophone is located in the deep layer, and the seismic signal is weak and prone to noise masking.

As described above, a seismic wave includes horizontal component signals composed of x and y components, and vertical component signals composed of z components, where x represents secondary wave (S-wave) and y represents primary wave (P-wave). That is, a horizontal component signal includes an x S-wave component signal and a y P-wave component signal. The scalar signal of the horizontal component is free from influence of the azimuth of the geophone, which can also reflect the event inclination angle and continuity in a polarization wave of the horizontal component of the seismic wave. Therefore, in the embodiment of the present disclosure, the horizontal component of the seismic wave is used to calculate the azimuth of the geophone.

Said determining, according to the horizontal component signals of the target seismic wave acquired by each of the geophones within the first arrival time window, an elliptical polarizability of the geophone specifically includes: calculating an average value of S-wave signals and an average value of P-wave signals acquired by a target geophone within the target first arrival time window, respectively; determining, according to the S-wave signals, the P-wave signals, the average value of the S-wave signals, and the average value of the P-wave signals, a covariance matrix corresponding to the horizontal component signals of the target seismic wave acquired by the target geophone; and determining, according to a ratio of a maximum eigenvalue to a minimum eigenvalue of the covariance matrix, an elliptical polarizability of the target geophone.

For each geophone, the x component signal and y component signal acquired at each acquisition time point in the corresponding first arrival time window are calculated respectively, and then the average values of x S-wave component signals and the average values of y P-wave component signals are calculated respectively, as shown in the following formula (1):

$$\{ \begin{matrix}\overline{{x}_{i} ( t )} = \frac{1}{N} {\sum }_{t = {t}_{fi} - wt}^{{t}_{fi} + wt} {x}_{i} ( t ) \\ \overline{{y}_{i} ( t )} = \frac{1}{N} {\sum }_{t = {t}_{fi} - wt}^{{t}_{fi} + wt} {y}_{i} ( t )\end{matrix} . \qquad ( 1 )$$

Where i denotes a number of a target geophone, e.g., the ith geophone, t denotes an acquisition time point of the ith geophone within the corresponding first arrival time window, xᵢ(t) and yᵢ(t) denote an x S-wave component signal and a y P-wave component signal acquired by the ith geophone at moment t, t_{fi} denotes a first arrival moment of the ith geophone, w denotes a half of a duration of the first arrival time window, and N denotes the number of acquisition time points within the first arrival time window.

After obtaining the average values of x S-wave component signals and the average values of y P-wave component signals, a covariance matrix is constructed according to x S-wave component signals, y P-wave component signals, average values of x S-wave component signals and average values of y P-wave component signals, as shown in the following formula (2):

$${M}_{i} = \qquad ( 2 )$$

$$[ \begin{matrix}{\sum }_{t = {t}_{fi} - wt}^{{t}_{fi} + wt} {( {x}_{i} ( t ) - \overline{{x}_{i} ( t )} )}^{2} & {\sum }_{t = {t}_{fi} - wt}^{{t}_{fi} + wt} ( {x}_{j} ( t ) - \overline{{x}_{i} ( t )} ) ( {y}_{i} ( t ) - \overline{{y}_{i} ( t )} ) \\ {\sum }_{t = {t}_{fi} - wt}^{{t}_{fi} + wt} ( {x}_{j} ( t ) - \overline{{x}_{i} ( t )} ) ( {y}_{i} ( i ) - \overline{{y}_{i} ( t )} & {\sum }_{t = {t}_{fi} - wt}^{{t}_{fi} + wt} {( {y}_{i} ( t ) - \overline{{y}_{i} ( t )} )}^{2}\end{matrix} ] .$$

According to the eigenvectors corresponding to the constructed covariance matrix, the maximum eigenvalue and the minimum eigenvalue of the matrix can be calculated. One geophone has a maximum eigenvalue and a minimum eigenvalue within its first arrival time window.

The ratio of the maximum eigenvalue to the minimum eigenvalue of the covariance matrix is the elliptical polarizability of the ith geophone, and the elliptical polarizability corresponding to each geophone is compared with the set polarizability threshold. According to an embodiment, a polarizability threshold may be set between 0.01 and 1. If the set polarizability threshold is not exceeded, the horizontal components of a seismic wave acquired by the geophone exhibits linear polarization, and the geophone is a shallow geophone. On the contrary, if the set polarizability threshold is exceeded, the horizontal components of a seismic wave acquired by the geophone exhibits nonlinear polarization, and the geophone is a deep geophone.

Therefore, according to the elliptical polarizability determined by the horizontal component signals of the seismic wave acquired by each geophone within the first arrival time window, geophones are divided into shallow geophones and deep geophones.

Based on the solution according to the above embodiment, optionally, in another embodiment, said determining shallow and deep geophones in a plurality of geophones sequentially arranged at a preset interval from top to bottom in a vertical depth direction in step 102 specifically includes: determining the geophones arranged at the top in the vertical depth direction as the shallow geophones; and determining the geophones below the geophones arranged at the top in the vertical depth direction, as the deep geophones.

In this embodiment, depending on the physical positions of geophones, the uppermost geophone closest to the wellhead is directly determined as a shallow geophone, and the other geophones below the shallow geophone are uniformly determined as deep geophones.

After determining whether the geophone is a shallow geophone or a deep geophone, for different types of geophones, their azimuths are determined in different ways.

In step 104, regarding each of the shallow geophones, its azimuth is determined based on the preliminary seismic wave signals acquired within the first arrival time window. In step 106, regarding each of the deep geophones, its azimuth is determined based on the full seismic wave signals acquired within the preset acquisition time window.

In the embodiment according to the present disclosure, for both preliminary seismic wave signal and full seismic wave signal, the horizontal component signals of the seismic wave, namely x and y components are used to determine the azimuth of the geophone.

The steps of determining the azimuth of a shallow geophone and the azimuth of a deep geophone will be described below in detail.

As mentioned above, regarding the shallow geophone, the azimuth is determined based on the horizontal component signals of a first arrival seismic wave acquired within the and first arrival time window.

Optionally, said determining, according to horizontal component signals of a target seismic wave acquired by each of the shallow geophones within a first arrival time window and a preset function, a polarization direction of the horizontal component signal acquired within the first arrival time window includes: calculating an average value of S-wave signals and an average value of P-wave signals acquired by a target shallow geophone within the first arrival time window, respectively; determining, according to the S-wave signals, the P-wave signals, the average value of the S-wave signals, and the average value of the P-wave signals, a covariance matrix corresponding to the horizontal component signals of the target seismic wave acquired by the target shallow geophone; and determining, according to an eigenvector corresponding to a maximum eigenvalue of the covariance matrix, a polarization direction of the horizontal component signals of the target seismic wave acquired by the target shallow geophone.

Here, the average value of S-wave signals, the average value of P-wave signals acquired by the target shallow geophone within the first arrival time window and the covariance matrix are solved by using the above formulas (1) and (2), respectively. Formulas (1) and (2) are exactly preset functions.

In the covariance matrix corresponding to formula (2), according to the eigenvector corresponding to the maximum eigenvalue of the covariance matrix, the (x, y) coordinate values of the x S-wave component signals and the y P-wave component signals of the seismic wave can be obtained. The (x, y) coordinate values indicate a direction, namely the polarization direction of the horizontal component signals of the target seismic wave, which is the azimuth of the ith shallow geophone.

The above algorithm for calculating an azimuth of a geophone based on a covariance matrix is also called a Singular Value Decomposition (SVD) algorithm of a matrix.

As regards embodiments in which shallow and deep geophones are distinguished according to the elliptical polarizability, there may be a plurality of shallow geophones, and then for each shallow geophone, the azimuth of each geophone at the corresponding depth position is calculated based on the x S-wave components and y P-wave components acquired by the geophone within the first arrival time window, respectively.

As regards embodiments in which the uppermost geophone is classified as shallow geophone according to the depth position, there is only one shallow geophone, and then according to the x S-wave components and y P-wave components acquired by the shallow geophone within the corresponding first arrival time window, the azimuth of the shallow geophone is calculated.

As mentioned above, regarding the deep geophone, its azimuth is determined based on the horizontal component signals of full seismic waves acquired within the preset acquisition time window.

Optionally, said determining an azimuth of each of the deep geophones specifically includes: determining, according to the horizontal component signals of the target seismic wave acquired by a target deep geophone at a target moment within the preset acquisition time window, a target scalar signal; determining an event inclination angle of the target scalar signal; determining, under each azimuth, a correlation between the target deep geophone and a forward adjacent geophone in horizontal component signal based on the event inclination angle; and determining, according to an azimuth corresponding to the maximum correlation, the azimuth of the target deep geophone.

The forward adjacent geophones refer to the geophones adjacent to the current geophone but closer to the wellhead, where there may be a plurality of forward adjacent geophones. For example, when the current geophone is the 10th geophone, there are 3 forward adjacent geophones, namely the 7th geophone, the 8th geophone and the 9th geophone; or alternatively there are 5 forward adjacent geophones, namely the 5th geophone, the 6th geophone, the 7th geophone, the 8th geophone and the 9th geophone.

In this embodiment, according to the scalar signal of the horizontal component signals of the seismic wave acquired by the deep geophone within the preset acquisition time window, the event inclination angle corresponding to the scalar signal, and the correlation between the target deep geophone and the forward adjacent geophone in horizontal component signals calculated based on the event inclination angle, the azimuth of the target deep geophone is determined. Each of deep geophones calculates the azimuth non-independently, but depending on the forward adjacent geophones.

First, by using the horizontal component signals of the target seismic wave acquired by the geophone, namely, the x S-wave component signals and the y P-wave component signals, the scalar signals of the horizontal component signals are calculated, as shown in the following formula (3):

Sᵢ(t)=\sqrt{x²ᵢ(t)+y²ᵢ(t)} (3).

In one embodiment, the scalar magnitude of the horizontal component signals may also be denoted by the sum of squares of xᵢ(t) and yᵢ(t), and the formula (3) denotes the scalar values of the depth domain in which the target geophone is located and the time domain at which the horizontal component signals are acquired.

The event of the scalar signals of the horizontal components of the seismic wave is continuous, and the inclination angle of the event indicates the apparent velocity of the seismic wave. Therefore, in the embodiment of the present disclosure, the event inclination angle is calculated as a constraint condition for determining the azimuth of the geophone.

For the target scalar signal corresponding to a certain acquisition time point, the event inclination angle can be calculated by using the following formula (4):

$${σ}_{i , t} \approx - \frac{{FFT}^{- 1} [ {{H}_{HT} ( i )}_{i , t} ]}{{FFT}^{- 1} [ {{H}_{HT} ( t )}_{i , t} ]} . \qquad ( 4 )$$

Where FFT denotes a fast Fourier transform function, and H_{HT} denotes a Hilbert transform function.

The Hilbert transform can be performed on the scalar signals (Sᵢ(t)) of the horizontal component signals of a seismic wave in the depth domain direction i (namely, corresponding to the depth of the ith geophone) and the time domain direction t (namely, corresponding to the moment at which the horizontal component data is acquired by the ith geophone), to obtain a more accurate event inclination angle of the scalar signal.

The above formula (4) represents according to the horizontal component signals acquired by the geophone of a depth position at different acquisition time points within the preset acquisition time window, an event inclination angle being calculated.

Then, the correlations between the target deep geophone and the forward adjacent geophone in horizontal component signals can be obtained with different azimuths based on the event inclination angle calculated by the target deep geophone within the acquisition time window.

Optionally, said determining, under various azimuths, correlations between the target deep geophone and a forward adjacent geophone in horizontal component signal based on the event inclination angle specifically includes: determining, according to the horizontal component signals of the target seismic wave acquired by the target deep geophone at various moments within the preset acquisition time window, a scalar signal corresponding to each moment and a radial seismic wave component and a tangential seismic wave component of the target seismic wave under each azimuth; determining an event inclination angle corresponding to the scalar signal at each moment; determining, according to event inclination angles of the target deep geophone at various moments within the preset acquisition time window, and an interval between the target deep geophone and a forward adjacent geophone in the vertical depth direction, a correlation between the target deep geophone and the forward adjacent geophone in radial seismic wave component based on the event inclination angle and a correlation between the target deep geophone and the forward adjacent geophone in tangential seismic wave component; and determining, according to a sum of the correlation in radial seismic wave components and the correlation in tangential seismic wave components, a correlation in horizontal component signals.

Assuming that the azimuth of the target deep geophone i (namely the ith geophone) is α_{d}, then according to the horizontal component signal acquired by the target deep geophone i at the target acquisition time t, the radial seismic wave component Rᵢ(t) and the tangential seismic wave component Tᵢ(t) corresponding to the acquired horizontal component signals are recovered, as shown in, the following formula (5).

$$[ \begin{matrix}{R}_{i} ( t ) \\ {T}_{i} ( t )\end{matrix} ] = [ \begin{matrix}sin {α}_{d} & cos {α}_{d} \\ cos {α}_{d} & - sin {α}_{d}\end{matrix} ] [ \begin{matrix}{x}_{i} ( t ) \\ {y}_{i} ( t )\end{matrix} ] . \qquad ( 5 )$$

The event of a scalar signal corresponding to the horizontal component signals acquired by the target deep geophone i at the target acquisition time t can be calculated according to the above formula (4). The correlation between target deep geophone i and forward adjacent geophone in radial seismic wave components and the correlation between target deep geophone i and forward adjacent geophone in tangential seismic wave components can be calculated by using the following formula (6):

$${C}_{RTi} ( {α}_{d} ) = \frac{{\sum }_{t = - w}^{w} {\prod }_{m = 0}^{M} {R}_{i - m} ( {t}_{imax} - τ - m Δ x tan {σ}_{i , t} )}{\sqrt{{\prod }_{m = 0}^{M} {\sum }_{t = - w}^{w} {R}_{i - m}^{2} ( {t}_{imax} - τ - m Δ x tan {σ}_{i , t} )}} + \frac{{\sum }_{t = - w}^{w} {\prod }_{m = 0}^{M} {T}_{i - m} ( {t}_{imax} - τ - m Δ x tan {σ}_{i , t} )}{\sqrt{{\prod }_{m = 0}^{M} {\sum }_{t = - w}^{w} {T}_{i - m}^{2} ( {t}_{imax} - τ - m Δ x tan {σ}_{i , t} )}} , \qquad ( 6 )$$

$$i \geq {H}_{0} .$$

Where m denotes the number of geophones adjacent to the target deep geophone i in the forward direction, such as 3 adjacent geophones or 5 adjacent geophones in the forward direction; τ denotes the acquisition time window, w represents w sampling points before the target acquisition time point, and −w represents w sample points after the target acquisition time point. Δx denotes an interval between the target deep geophone i and the forward adjacent geophones. tᵢₘₐₓ denotes an acquisition time point in the preset acquisition time window, at which the correlation between the target depth geophone i and the forward adjacent geophones in horizontal component signals reach a maximum, and H₀ denotes the number of geophones at a boundary point that distinguishes the shallow geophones from the deep geophones.

If the correlation is calculated at all the acquisition time points in the preset acquisition time window of the full time window under different angle, a large amount of computation is required. In the embodiments of the present disclosure, for the purpose of improving the operating speed and reducing a large number of unnecessary computation, the acquisition time point with the maximum correlation between the target deep geophone i and a forward adjacent geophone in horizontal component signals is selected, then a time window is determined according to the acquisition time point with the maximum correlation, and the correlation between the target deep geophone i and the forward adjacent geophone in radial seismic wave components, and the correlation between the target deep geophone i and the forward adjacent geophone in tangential seismic wave components are calculated.

Optionally, said determining, according to an event inclination angle of the target deep geophone at each moment within the preset acquisition time window and an interval between the target deep geophone and a forward adjacent geophone in the vertical depth direction, a correlation between the target deep geophone and the forward adjacent geophone in radial seismic wave component based on the event inclination angle and a correlation between the target deep geophone and the forward adjacent geophone in tangential seismic wave component specifically includes: determining, according to an event inclination angel of the target deep geophone at each moment within the preset acquisition time window and an interval between the target deep geophone and a forward adjacent geophone in the vertical depth direction, a correlation between the target deep geophone and the forward adjacent geophone in horizontal component signal based on the event inclination angle at each moment within the preset acquisition time window; determining, from all moments, a target moment corresponding to a maximum correlation in horizontal component signal; determining a constraint time window according to the target moment, where a time length of the constraint time window is less than that of the preset acquisition time window; and determining, according to an event inclination angle of the target deep geophone at each moment within the constraint time window and an interval between the target deep geophone and a forward adjacent geophone in the vertical depth direction, a correlation between the target deep geophone and the forward adjacent geophone in radial seismic wave component based on the event inclination angle and a correlation between the target deep geophone and the forward adjacent geophone in tangential seismic wave component.

The correlation between the target deep geophone i and a forward adjacent geophone in horizontal component signal can be determined by the following formula (7):

$${C}_{i} ( t ) = \frac{{\sum }_{t = - w}^{w} {\prod }_{m = 0}^{M} {S}_{i - m} ( t - τ - m Δ x tan {σ}_{i , t} )}{\sqrt{{\prod }_{m = 0}^{M} {\sum }_{t = - w}^{w} {S}_{i - m}^{2} ( t - τ - m Δ x tan {σ}_{i , t} )}} . \qquad ( 7 )$$

The maximum value of correlation in horizontal component signals of the ith deep geophone is as follows:

C(tᵢₘₐₓ)=max{Cᵢ(t)} (8).

The time point within the acquisition time window corresponding to the maximum value of correlation is the acquisition time point tᵢₘₐₓ with the maximum correlation in horizontal component signals between the target deep geophone i and the forward adjacent geophone.

With the time point tᵢₘₐₓ as the center point, the constraint time window of the preset time window can be obtained, which, for example, includes w acquisition time points distributed around the time point tᵢₘₐₓ, and is much smaller than the full acquisition time window. By calculating the correlation between the deep geophone and the forward adjacent geophone in radial seismic wave component and the correlation between the deep geophone and the forward adjacent geophone in tangential seismic wave component within the constrained time window, the amount of computation can be significantly reduced, and the efficiency of computation can be improved on the premise of ensuring the accuracy of correlation.

Return to formula (6), in the case of different azimuths, according to an event inclination angle of the target deep geophone i at each moment within the time window, and an interval Δx between the target deep geophone i and m forward adjacent geophones in the vertical depth direction, a correlation between the target deep geophone i and the m forward adjacent geophones in radial seismic wave components and a correlation between the target deep geophone i and the m forward adjacent geophones in tangential seismic wave components may be calculated.

Different azimuths have different values ranging from 0 degree to 360 degrees, and for example, are assigned with a sequence of angular values incremented by 5 degrees for calculating the correlation. As a result, the correlation between the target deep geophone i and the forward adjacent m geophones in radial seismic wave component, the correlation between the target deep geophone i and the forward adjacent m geophones in tangential seismic wave component, and a sum of the correlation in radial seismic wave component and the correlation in tangential seismic wave component under respective azimuths can be obtained.

If a series of geophones arranged in the well have the same azimuth, the received target seismic signals are similar, and the target seismic signals are propagated forward at the same wavelength. When the sum of the correlation in radial seismic wave component and the correlation in tangential seismic wave component reaches the maximum, the azimuth α_{d} corresponding to the maximum of the correlation sum is the azimuth of the target deep geophone i.

As a result, the azimuth of the shallow geophone and the azimuth of the deep geophone have been determined, and according to formula (5), the azimuth of each geophone is used to perform calculation in conjunction with horizontal component signal of a target seismic wave acquired by the geophone. In this way, the original horizontal component signals acquired can be restored to radial seismic wave component and tangential seismic wave components of the original target seismic wave. That is, vertically polarized S waves (SV waves) of the radial (R) component and horizontally polarized S waves (SH) waves of the tangential (T) component of the target seismic wave are obtained.

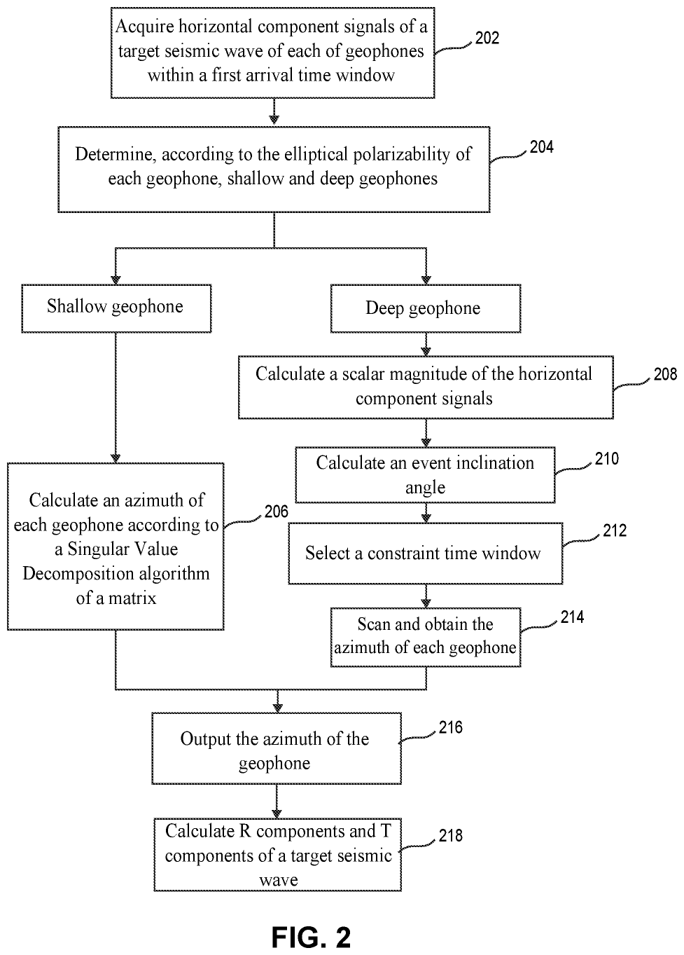

Referring now to FIG. 2, FIG. 2 is a schematic flowchart of a method for determining seismic wave information according to an example of the present disclosure.

According to this embodiment, shallow and deep geophones in all of the geophones are determined according to the elliptical polarizability.

As shown in FIG. 2, the method includes the following steps.

In step 202, horizontal component signals of a target seismic wave of each of geophones within a first arrival time window are acquired.

In step 204, according to the elliptical polarizability of each geophone, shallow and deep geophones are determined.

In step 206, for the shallow geophones, an azimuth of each geophone is calculated according to a Singular Value Decomposition algorithm of a matrix.

In step 208, for the deep geophones, a scalar magnitude of the horizontal component signals is calculated.

In step 210, an event inclination angle of a scalar signal in the horizontal component signals is calculated.

In step 212, a constraint time window is selected according to the time point corresponding to the maximum correlation.

In step 214, the azimuth of each geophone is obtained, and the sum of the correlation in radial seismic wave component and the correlation in tangential seismic wave component for each geophone within the constraint time window is calculated.

In step 216, the azimuth of the geophone is outputted according to a maximum of the sum of correlations.

In step 218, according to the azimuth of the geophone, R components and T components of a target seismic wave are calculated.

In the embodiments of the present disclosure, the method includes: determining shallow and deep geophones from a plurality of geophones sequentially arranged at a preset interval from top to bottom in a vertical depth direction; determining, according to horizontal component signals of a target seismic wave acquired by each of the shallow geophones within a corresponding first arrival time window and a preset function, a polarization direction of the horizontal component signal acquired within the corresponding first arrival time window to obtain an azimuth of the shallow geophone; determining, according to an event inclination angle of a scalar signal in horizontal component signals of the target seismic wave acquired by each of the deep geophones within a preset acquisition time window, and a correlation between the deep geophone and a forward adjacent geophone in horizontal component signal based on the event inclination angle, an azimuth of the deep geophone; and determining, according to the horizontal component signals of the target seismic wave acquired within the preset acquisition time window and the azimuth of each of the geophones, a radial seismic wave component and a tangential seismic wave component of the target seismic wave. As a result, the problem that it is difficult to obtain accurate azimuths of a geophone by using preliminary seismic waves due to noise masking can be avoided, so as to improve the accuracy of the azimuth of each geophone, and thus the wave field information of the target seismic wave can be recovered accurately and effectively.

Optionally, the embodiments of the present disclosure further provide a device for determining seismic wave information. As shown in FIG. 2, the device 2000 for determining seismic wave information includes a memory 2200 and a processor 2400, where the processor is electrically connected to the memory 2200; the memory 2200 stores a computer program executable on the processor 2400; and the computer program is executed by the processor to implement processes of the method for determining seismic wave information in any of the foregoing embodiments, and the same technical effect can be achieved. The details are not repeated herein for brevity.

An embodiment of the present disclosure further provides a computer readable storage medium. The computer readable storage medium stores a computer program. The computer program, when executed by a processor, implements processes of the method for determining seismic wave information in any of the foregoing embodiments, and the same technical effect can be achieved. The details are not repeated herein for brevity. The foregoing computer readable storage medium includes any medium, such as a read-only memory (ROM), a random access memory (RAM), a magnetic disk, or an optical disc.

It should be noted that terms “including”, “comprising” or any other variants thereof are intended to cover non-exclusive inclusion, so that a process, method, article or device including a series of elements includes not only those elements but also other elements not explicitly listed, or elements inherent to such a process, method, article, or device. Without further limitation, an element qualified by the phrase “including a . . . ” does not exclude the presence of an additional identical element in the process, method, article, or device including the element.

By means of the above description of the examples, those skilled in the art can clearly understand that the above method in the examples may be implemented by means of software and a necessary general-purpose hardware platform. Certainly, the above method in the examples also may be implemented by means of hardware, but the former is a better implementation manner in many cases. Based on this understanding, the technical solution of the present disclosure essentially, or a part contributing to the prior art, may be embodied in a form of a software product. The computer software product is stored on a storage medium (such as a ROM/RAM, a magnetic disk, an optical disk), and includes several instructions to enable a terminal device (may be a mobile phone, a computer, a server, an air conditioner, or a network device) to execute the method according to each example of the present disclosure.

The embodiments of the present disclosure have been described above with reference to the accompanying drawings, but the present disclosure is not limited to the foregoing specific embodiments. The foregoing specific embodiments are only illustrative and not restrictive. Under the inspiration of the present disclosure, those of ordinary skills in the art can make many improvements without departing from the purpose of the present disclosure and the protection scope defined by the claims, and these improvements shall fall within the protection scope of the present disclosure.

1-20. (canceled)

21. A method for determining seismic wave information, comprising:
determining shallow and deep geophones from a plurality of geophones sequentially arranged at a preset interval from top to bottom in a vertical depth direction;
determining, according to horizontal component signals of a target seismic wave acquired by each of the shallow geophones within a corresponding first arrival time window and a preset function, a polarization direction of the horizontal component signals acquired within the corresponding first arrival time window to obtain an azimuth of the shallow geophone;
determining, according to an event inclination angle of a scalar signal in horizontal component signals of the target seismic wave acquired by each of the deep geophones within a preset acquisition time window, and a correlation between the deep geophone and a forward adjacent geophone in horizontal component signal based on the event inclination angle, an azimuth of the deep geophone, wherein the preset acquisition time window comprises the first arrival time window; and
determining, according to the horizontal component signals of the target seismic wave acquired within the preset acquisition time window and the azimuth of each of geophones, a radial seismic wave component and a tangential seismic wave component of the target seismic wave;
wherein said determining an azimuth of each of the deep geophones comprises: determining, according to the horizontal component signals of the target seismic wave acquired by a target deep geophone at a target moment within the preset acquisition time window, a target scalar signal; determining an event inclination angle of the target scalar signal; determining, under each of different azimuths, a correlation between the target deep geophone and a forward adjacent geophone in horizontal component signal based on the event inclination angle; and determining, according to an azimuth corresponding to a maximum of correlations under the different azimuths, the azimuth of the target deep geophone;
wherein said determining, under each azimuth of the different azimuths, a correlation between the target deep geophone and a forward adjacent geophone in horizontal component signal based on the event inclination angle comprises: determining, according to a horizontal component signal of the target seismic wave acquired by the target deep geophone at each moment within the preset acquisition time window, a scalar signal corresponding to each moment and a radial seismic wave component and a tangential seismic wave component of the target seismic wave under each azimuth; determining an event inclination angle corresponding to the scalar signal at each moment; determining, according to an event inclination angle of the target deep geophone at each moment within the preset acquisition time window, and an interval between the target deep geophone and a forward adjacent geophone in the vertical depth direction, a correlation between the target deep geophone and the forward adjacent geophone in radial seismic wave component based on the event inclination angle and a correlation between the target deep geophone and the forward adjacent geophone in tangential seismic wave component based on the event inclination angle; and determining, according to a sum of the correlation in radial seismic wave component and the correlation in tangential seismic wave component, a correlation in horizontal component signal.

22. The method according to claim 21, wherein said determining shallow and deep geophones from a plurality of geophones sequentially arranged at a preset interval from top to bottom in a vertical depth direction comprises:
determining, according to the horizontal component signals of the target seismic wave acquired by each of the geophones within the corresponding first arrival time window, an elliptical polarizability of the geophone; and
determining, according to respective elliptical polarizabilities of the geophones, shallow and deep geophones from the plurality of geophones.

23. The method according to claim 22, wherein the horizontal component signals of the target seismic wave comprise Secondary wave (S-wave) signals and primary wave (P-wave) signals, and
said determining, according to the horizontal component signals of the target seismic wave acquired by each of the geophones within the corresponding first arrival time window, an elliptical polarizability of the geophone comprises:
calculating an average value of S-wave signals and an average value of P-wave signals acquired by a target geophone within a target first arrival time window;
determining, according to the S-wave signals, the P-wave signals, the average value of the S-wave signals, and the average value of the P-wave signals, a covariance matrix corresponding to the horizontal component signals of the target seismic wave acquired by the target geophone; and
determining, according to a ratio of a maximum eigenvalue to a minimum eigenvalue of the covariance matrix, an elliptical polarizability of the target geophone.

24. The method according to claim 21, wherein said determining shallow and deep geophones from a plurality of geophones sequentially arranged at a preset interval from top to bottom in a vertical depth direction comprises:
determining a geophone arranged at an uppermost part in the vertical depth direction as a shallow geophone; and
determining other geophones below the geophone arranged at the uppermost part in the vertical depth direction as deep geophones.

25. The method according to claim 23, wherein said determining, according to horizontal component signals of a target seismic wave acquired by each of the shallow geophones within a corresponding first arrival time window and a preset function, a polarization direction of the horizontal component signal acquired within the corresponding first arrival time window comprises:
calculating an average value of S-wave signals and an average value of P-wave signals acquired by a target shallow geophone within the corresponding first arrival time window;
determining, according to the S-wave signals, the P-wave signals, the average value of the S-wave signals, and the average value of the P-wave signals, a covariance matrix corresponding to the horizontal component signals of the target seismic wave acquired by the target shallow geophone; and
determining, according to an eigenvector corresponding to a maximum eigenvalue of the covariance matrix, a polarization direction of the horizontal component signals of the target seismic wave acquired by the target shallow geophone.

26. The method according to claim 24, wherein said determining, according to horizontal component signals of a target seismic wave acquired by each of the shallow geophones within a corresponding first arrival time window and a preset function, a polarization direction of the horizontal component signal acquired within the corresponding first arrival time window comprises:
calculating an average value of S-wave signals and an average value of P-wave signals acquired by a target shallow geophone within the corresponding first arrival time window;
determining, according to the S-wave signals, the P-wave signals, the average value of the S-wave signals, and the average value of the P-wave signals, a covariance matrix corresponding to the horizontal component signals of the target seismic wave acquired by the target shallow geophone; and
determining, according to an eigenvector corresponding to a maximum eigenvalue of the covariance matrix, a polarization direction of the horizontal component signals of the target seismic wave acquired by the target shallow geophone.

27. The method according to claim 21, wherein said determining, according to an event inclination angle of the target deep geophone at each moment within the preset acquisition time window, and an interval between the target deep geophone and a forward adjacent geophone in the vertical depth direction, a correlation between the target deep geophone and the forward adjacent geophone in radial seismic wave component based on the event inclination angle and a correlation between the target deep geophone and the forward adjacent geophone in tangential seismic wave component based on the event inclination angle comprises:
determining, according to an event inclination angle of the target deep geophone at each moment within the preset acquisition time window, and an interval between the target deep geophone and a forward adjacent geophone in the vertical depth direction, a correlation between the target deep geophone and the forward adjacent geophone in horizontal component signal based on the event inclination angle at each moment within the preset acquisition time window;
determining, from all moments, a target moment corresponding to a maximum of correlations in horizontal component signal for all moments;
determining a constraint time window according to the target moment, wherein a time length of the constraint time window is less than that of the preset acquisition time window; and
determining, according to an event inclination angle of the target deep geophone at each moment within the constraint time window, and an interval between the target deep geophone and a forward adjacent geophone in the vertical depth direction, a correlation between the target deep geophone and the forward adjacent geophone in radial seismic wave component based on the event inclination angle and a correlation between the target deep geophone and the forward adjacent geophone in tangential seismic wave component based on the event inclination angle.

28. A device for determining seismic wave information, comprising a memory and a processor, wherein the processor is electrically connected to the memory; the memory stores a computer program executable on the processor; and the computer program is executed by the processor to implement a method for determining seismic wave information, comprising:
determining shallow and deep geophones from a plurality of geophones sequentially arranged at a preset interval from top to bottom in a vertical depth direction;
determining, according to horizontal component signals of a target seismic wave acquired by each of the shallow geophones within a corresponding first arrival time window and a preset function, a polarization direction of the horizontal component signals acquired within the corresponding first arrival time window to obtain an azimuth of the shallow geophone;
determining, according to an event inclination angle of a scalar signal in horizontal component signals of the target seismic wave acquired by each of the deep geophones within a preset acquisition time window, and a correlation between the deep geophone and a forward adjacent geophone in horizontal component signal based on the event inclination angle, an azimuth of the deep geophone, wherein the preset acquisition time window comprises the first arrival time window; and
determining, according to the horizontal component signals of the target seismic wave acquired within the preset acquisition time window and the azimuth of each of geophones, a radial seismic wave component and a tangential seismic wave component of the target seismic wave;
wherein said determining an azimuth of each of the deep geophones comprises: determining, according to the horizontal component signals of the target seismic wave acquired by a target deep geophone at a target moment within the preset acquisition time window, a target scalar signal; determining an event inclination angle of the target scalar signal; determining, under each of different azimuths, a correlation between the target deep geophone and a forward adjacent geophone in horizontal component signal based on the event inclination angle; and determining, according to an azimuth corresponding to a maximum of correlations under the different azimuths, the azimuth of the target deep geophone;
wherein said determining, under each azimuth of the different azimuths, a correlation between the target deep geophone and a forward adjacent geophone in horizontal component signal based on the event inclination angle comprises: determining, according to a horizontal component signal of the target seismic wave acquired by the target deep geophone at each moment within the preset acquisition time window, a scalar signal corresponding to each moment and a radial seismic wave component and a tangential seismic wave component of the target seismic wave under each azimuth; determining an event inclination angle corresponding to the scalar signal at each moment; determining, according to an event inclination angle of the target deep geophone at each moment within the preset acquisition time window, and an interval between the target deep geophone and a forward adjacent geophone in the vertical depth direction, a correlation between the target deep geophone and the forward adjacent geophone in radial seismic wave component based on the event inclination angle and a correlation between the target deep geophone and the forward adjacent geophone in tangential seismic wave component based on the event inclination angle; and determining, according to a sum of the correlation in radial seismic wave component and the correlation in tangential seismic wave component, a correlation in horizontal component signal.

29. The method according to claim 28, wherein said determining shallow and deep geophones from a plurality of geophones sequentially arranged at a preset interval from top to bottom in a vertical depth direction comprises:
determining, according to the horizontal component signals of the target seismic wave acquired by each of the geophones within the corresponding first arrival time window, an elliptical polarizability of the geophone; and
determining, according to respective elliptical polarizabilities of the geophones, shallow and deep geophones from the plurality of geophones.

30. The method according to claim 29, wherein the horizontal component signals of the target seismic wave comprise Secondary wave (S-wave) signals and primary wave (P-wave) signals, and
said determining, according to the horizontal component signals of the target seismic wave acquired by each of the geophones within the corresponding first arrival time window, an elliptical polarizability of the geophone comprises:
calculating an average value of S-wave signals and an average value of P-wave signals acquired by a target geophone within a target first arrival time window;
determining, according to the S-wave signals, the P-wave signals, the average value of the S-wave signals, and the average value of the P-wave signals, a covariance matrix corresponding to the horizontal component signals of the target seismic wave acquired by the target geophone; and
determining, according to a ratio of a maximum eigenvalue to a minimum eigenvalue of the covariance matrix, an elliptical polarizability of the target geophone.

31. The method according to claim 28, wherein said determining shallow and deep geophones from a plurality of geophones sequentially arranged at a preset interval from top to bottom in a vertical depth direction comprises:
determining a geophone arranged at an uppermost part in the vertical depth direction as a shallow geophone; and
determining other geophones below the geophone arranged at the uppermost part in the vertical depth direction as deep geophones.

32. The method according to claim 30, wherein said determining, according to horizontal component signals of a target seismic wave acquired by each of the shallow geophones within a corresponding first arrival time window and a preset function, a polarization direction of the horizontal component signal acquired within the corresponding first arrival time window comprises:
calculating an average value of S-wave signals and an average value of P-wave signals acquired by a target shallow geophone within the corresponding first arrival time window;
determining, according to the S-wave signals, the P-wave signals, the average value of the S-wave signals, and the average value of the P-wave signals, a covariance matrix corresponding to the horizontal component signals of the target seismic wave acquired by the target shallow geophone; and
determining, according to an eigenvector corresponding to a maximum eigenvalue of the covariance matrix, a polarization direction of the horizontal component signals of the target seismic wave acquired by the target shallow geophone.

33. The method according to claim 31, wherein said determining, according to horizontal component signals of a target seismic wave acquired by each of the shallow geophones within a corresponding first arrival time window and a preset function, a polarization direction of the horizontal component signal acquired within the corresponding first arrival time window comprises:
calculating an average value of S-wave signals and an average value of P-wave signals acquired by a target shallow geophone within the corresponding first arrival time window;
determining, according to the S-wave signals, the P-wave signals, the average value of the S-wave signals, and the average value of the P-wave signals, a covariance matrix corresponding to the horizontal component signals of the target seismic wave acquired by the target shallow geophone; and
determining, according to an eigenvector corresponding to a maximum eigenvalue of the covariance matrix, a polarization direction of the horizontal component signals of the target seismic wave acquired by the target shallow geophone.

34. The method according to claim 38, wherein said determining, according to an event inclination angle of the target deep geophone at each moment within the preset acquisition time window, and an interval between the target deep geophone and a forward adjacent geophone in the vertical depth direction, a correlation between the target deep geophone and the forward adjacent geophone in radial seismic wave component based on the event inclination angle and a correlation between the target deep geophone and the forward adjacent geophone in tangential seismic wave component based on the event inclination angle comprises:
determining, according to an event inclination angle of the target deep geophone at each moment within the preset acquisition time window, and an interval between the target deep geophone and a forward adjacent geophone in the vertical depth direction, a correlation between the target deep geophone and the forward adjacent geophone in horizontal component signal based on the event inclination angle at each moment within the preset acquisition time window;
determining, from all moments, a target moment corresponding to a maximum of correlations in horizontal component signal for all moments;
determining a constraint time window according to the target moment, wherein a time length of the constraint time window is less than that of the preset acquisition time window; and
determining, according to an event inclination angle of the target deep geophone at each moment within the constraint time window, and an interval between the target deep geophone and a forward adjacent geophone in the vertical depth direction, a correlation between the target deep geophone and the forward adjacent geophone in radial seismic wave component based on the event inclination angle and a correlation between the target deep geophone and the forward adjacent geophone in tangential seismic wave component based on the event inclination angle.

35. A computer readable storage medium having a computer program stored thereon, and the computer program, when executed by a processor, implements a method for determining seismic wave information, comprising:
determining shallow and deep geophones from a plurality of geophones sequentially arranged at a preset interval from top to bottom in a vertical depth direction;
determining, according to horizontal component signals of a target seismic wave acquired by each of the shallow geophones within a corresponding first arrival time window and a preset function, a polarization direction of the horizontal component signals acquired within the corresponding first arrival time window to obtain an azimuth of the shallow geophone;
determining, according to an event inclination angle of a scalar signal in horizontal component signals of the target seismic wave acquired by each of the deep geophones within a preset acquisition time window, and a correlation between the deep geophone and a forward adjacent geophone in horizontal component signal based on the event inclination angle, an azimuth of the deep geophone, wherein the preset acquisition time window comprises the first arrival time window; and
determining, according to the horizontal component signals of the target seismic wave acquired within the preset acquisition time window and the azimuth of each of geophones, a radial seismic wave component and a tangential seismic wave component of the target seismic wave;
wherein said determining an azimuth of each of the deep geophones comprises: determining, according to the horizontal component signals of the target seismic wave acquired by a target deep geophone at a target moment within the preset acquisition time window, a target scalar signal; determining an event inclination angle of the target scalar signal; determining, under each of different azimuths, a correlation between the target deep geophone and a forward adjacent geophone in horizontal component signal based on the event inclination angle; and determining, according to an azimuth corresponding to a maximum of correlations under the different azimuths, the azimuth of the target deep geophone;
wherein said determining, under each azimuth of the different azimuths, a correlation between the target deep geophone and a forward adjacent geophone in horizontal component signal based on the event inclination angle comprises: determining, according to a horizontal component signal of the target seismic wave acquired by the target deep geophone at each moment within the preset acquisition time window, a scalar signal corresponding to each moment and a radial seismic wave component and a tangential seismic wave component of the target seismic wave under each azimuth; determining an event inclination angle corresponding to the scalar signal at each moment; determining, according to an event inclination angle of the target deep geophone at each moment within the preset acquisition time window, and an interval between the target deep geophone and a forward adjacent geophone in the vertical depth direction, a correlation between the target deep geophone and the forward adjacent geophone in radial seismic wave component based on the event inclination angle and a correlation between the target deep geophone and the forward adjacent geophone in tangential seismic wave component based on the event inclination angle; and determining, according to a sum of the correlation in radial seismic wave component and the correlation in tangential seismic wave component, a correlation in horizontal component signal.

36. The method according to claim 35, wherein said determining shallow and deep geophones from a plurality of geophones sequentially arranged at a preset interval from top to bottom in a vertical depth direction comprises:
determining, according to the horizontal component signals of the target seismic wave acquired by each of the geophones within the corresponding first arrival time window, an elliptical polarizability of the geophone; and
determining, according to respective elliptical polarizabilities of the geophones, shallow and deep geophones from the plurality of geophones.

37. The method according to claim 36, wherein the horizontal component signals of the target seismic wave comprise Secondary wave (S-wave) signals and primary wave (P-wave) signals, and
said determining, according to the horizontal component signals of the target seismic wave acquired by each of the geophones within the corresponding first arrival time window, an elliptical polarizability of the geophone comprises:
calculating an average value of S-wave signals and an average value of P-wave signals acquired by a target geophone within a target first arrival time window;
determining, according to the S-wave signals, the P-wave signals, the average value of the S-wave signals, and the average value of the P-wave signals, a covariance matrix corresponding to the horizontal component signals of the target seismic wave acquired by the target geophone; and
determining, according to a ratio of a maximum eigenvalue to a minimum eigenvalue of the covariance matrix, an elliptical polarizability of the target geophone.

38. The method according to claim 35, wherein said determining shallow and deep geophones from a plurality of geophones sequentially arranged at a preset interval from top to bottom in a vertical depth direction comprises:
determining a geophone arranged at an uppermost part in the vertical depth direction as a shallow geophone; and
determining other geophones below the geophone arranged at the uppermost part in the vertical depth direction as deep geophones.

39. The method according to claim 37, wherein said determining, according to horizontal component signals of a target seismic wave acquired by each of the shallow geophones within a corresponding first arrival time window and a preset function, a polarization direction of the horizontal component signal acquired within the corresponding first arrival time window comprises:
calculating an average value of S-wave signals and an average value of P-wave signals acquired by a target shallow geophone within the corresponding first arrival time window;
determining, according to the S-wave signals, the P-wave signals, the average value of the S-wave signals, and the average value of the P-wave signals, a covariance matrix corresponding to the horizontal component signals of the target seismic wave acquired by the target shallow geophone; and
determining, according to an eigenvector corresponding to a maximum eigenvalue of the covariance matrix, a polarization direction of the horizontal component signals of the target seismic wave acquired by the target shallow geophone.

40. The method according to claim 38, wherein said determining, according to horizontal component signals of a target seismic wave acquired by each of the shallow geophones within a corresponding first arrival time window and a preset function, a polarization direction of the horizontal component signal acquired within the corresponding first arrival time window comprises:
calculating an average value of S-wave signals and an average value of P-wave signals acquired by a target shallow geophone within the corresponding first arrival time window;
determining, according to the S-wave signals, the P-wave signals, the average value of the S-wave signals, and the average value of the P-wave signals, a covariance matrix corresponding to the horizontal component signals of the target seismic wave acquired by the target shallow geophone; and
determining, according to an eigenvector corresponding to a maximum eigenvalue of the covariance matrix, a polarization direction of the horizontal component signals of the target seismic wave acquired by the target shallow geophone.
